(19) United States
(12) Patent Application Publication
(10) Pub. No.: US 2005/0089652 A1
(43) Pub. Date: Apr. 28, 2005

(54) Inkjet recording sheet

(75) Inventors: Kenzo Kasahara, Tokyo (JP); Toshihiko Iwasaki, Tokyo (JP); Junji Ito, Tokyo (JP); Yukako Taka, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/971,092

(22) Filed: Oct. 25, 2004

(30) Foreign Application Priority Data
Oct. 28, 2003 (JP) JP2003-367130

(51) Int. Cl. B41M 5/00

(52) U.S. Cl. 428/32.34

(57) ABSTRACT

An inkjet recording sheet comprising on a water-nonabsorptive support a porous ink absorptive layer, wherein; said porous ink absorptive layer is formed by utilizing a composition containing inorganic micro-particles, polyvinyl alcohol and an organic polymer having an epoxy group, and contains a polyvalent metal compound provided with a polyvalent metal element.

### BACKGROUND OF THE INVENTION

The present invention relates to a new inkjet recording sheet and specifically to an inkjet recording sheet exhibiting improved bleeding resistance, coating defect resistance and ink absorbability.

An inkjet recording method performs recording of letters and images by flying ink micro-droplets to be adhered onto an inkjet recording sheet such as paper based on various operation principles, having advantages of easiness to achieve such as relatively high speed, low noise and multi-color, and is prevailing in a variety of fields such-as various printers, facsimiles, computer terminals.

On the other hand, in inkjet recording materials, formed images are approaching to photography in image quality. In particular, to achieve image quality comparative to photographic image quality, improvement with respect to an inkjet recording sheet (hereinafter, referred to also simply as a recording sheet) is also in progress, and a recording sheet, in which an ink absorptive layer having micro voids comprising micro-particles and a hydrophilic polymer, is provided on a support having a high smoothness is coming to be one of recording sheets giving nearest photographic image quality, because it exhibits a high gloss and bright color formation as well as is excellent in ink absorbability and a drying property. In particular, in the case of utilizing a water-nonabsorptive support, there generate no cocklings, that is so-called “wrinkles”, after printing, which are observed in the case of utilizing a water-absorptive support after printing resulting in a print of a higher quality.

In the case of utilizing a water-nonabsorptive support like this manner, generation of wrinkles and roughness are prevented resulting in a print of higher quality as described above, however, on the other hand, an ink absorption layer has to hold all the ejected ink resulting in causing not a few problems. One problem among them includes an image bleeding during storage. An organic solvent (such as diethylene glycol and glycerin) remains in an ink-absorptive layer after printing, which acts as a moisture-retaining agent to locally raise humidity of an ink absorptive layer, resulting in being liable to induce image bleeding due to migration of a colorant especially of a dye. To solve this problem, proposed is a method in which a cationic polymer is utilized which fix a dye in an ink absorptive layer of an inkjet recording sheet, for example in a pamphlet of International Publication No. 99/64248. Further, proposed is a method in which a polyvalent metal compound to fix a dye is utilized, for example, in JP-A-No. 2002-192830 (hereinafter, JP-A refers to Japanese Patent Publication Open to Public Inspection) and Japanese Patent No. 2944143. Among them, in particular, a polyvalent metal compound is useful to prevent image bleeding, however, is liable to induce problems such as bronzing (a state presenting metallic gloss like iridescent color) or shift of hue due to coagulation sedimentation of a dye. Further, a polyvalent metal compound includes problems of difficult compatibility with other compounds constituting an ink absorptive layer coating solution and of easy increase of a viscosity or easy aggregation of a coating solution.

### SUMMARY OF THE INVENTION

According to one embodiment of the invention, an inkjet recording sheet is provided, the sheet comprises on a water-nonabsorptive support a porous ink absorptive layer, and said porous ink absorptive layer is formed by utilizing a composition containing inorganic micro-particles, polyvinyl alcohol and an organic polymer having an epoxy group, and contains a polyvalent metal compound provided with a polyvalent metal element.

### DETAILED DESCRIPTION OF THE PREFERRED EMBODIMENT

In the following, the best embodiment to practice this invention will be detailed, however, this invention is not limited thereto.

An inkjet recording sheet of this invention is characterized by-having a porous ink absorptive layer formed by utilizing a composition containing inorganic micro-particles, polyvinyl alcohol and an organic polymer provided with an epoxy group on a water-nonabsorptive support, and containing a polyvalent metal compound provided with a polyvalent metal element.

A polyvalent metal compound according to this invention is preferably a compound provided with a zirconium atom or an aluminum atom in the molecule as a polyvalent metal element and more preferably a zirconium atom as a polyvalent metal.

A compound provided with a zirconium atom or an aluminum atom in the molecule which is preferably utilized in an inkjet recording sheet of this invention may be either water-soluble or water-insoluble itself, however, is preferably possible to be added uniformly in an ink absorptive layer and contained in an ink absorptive layer so as not to be eluted from the ink absorptive layer when it is immersed in pure water. Herein, the effects of this invention cannot be obtained when the compound presents in an ink absorptive layer as a state of oxides such as zirconium oxide and aluminum oxide.

A compound provided with a zirconium atom or an aluminum atom is known generally to bond with a hydroxyl group, and reacts with a hydrophilic binder, various types of polymers or additives to reduce the water-solubility resulting in being hardly eluted into pure water when an ink absorptive layer is immersed in pure water.

A compound provided with a zirconium atom or an aluminum atom may be either a simple salt or a complex salt of an inorganic acid or an organic acid, an organometallic compound or a metal complex, however, is preferably those which can be homogeneously incorporated in an ink absorptive layer.

Specific examples of a compound provided with a zirconium atom which can be utilized in this invention include zirconium difluoride, zirconium trifluoride, zirconium tetrafluoride, hexafluoro zirconate (for example, a potassium salt), heptafluoro zirconate (for example, a sodium salt, a potassium salt or an ammonium salt), octafluoro zirconate (for example, a lithium salt), zirconium oxyfluoride, zirconium dichloride, zirconium trichloride, zirconium tetrachloride, hexachloro zirconate (for example, a sodium salt or a potassium salt), zirconium oxychloride (for example, zirconyl chloride), acid sodium zylconyl dibromozirconate, acid zirconyl sulfate trihydrate, potassium zirconium sulfate, zirconium selenate, zirconium nitrate, zirconyl nitrate, zirconium phosphate, zirconyl carbonate, zirconyl ammonium carbonate, zirconium acetate, zirconyl acetate, zirconyl ammonium acetate, zirconyl lactate, zirconyl citrate, zirconyl stearate, zylconyl phosphate, zirconium oxalate, zirconium isopropylate, zirconium butylate, zirconium acetylacetonate, acetylacetone zirconium butylate, zirconium stearate butylate, bis(acetylacetonato)dichloro zirconium and tris(acetylacetonato)chloro zirconium.

Among these compounds containing a zirconium atom, preferable are zirconyl carbonate, zirconyl ammonium carbonate, zirconyl acetate, zirconyl nitrate, zirconium oxychloride, zirconyl lactate and zirconyl citrate and specifically preferable are zirconyl ammonium carbonate, zirconyl acetate and zirconium oxychloride.

Specific examples of a compound provided with a aluminum atom which can be utilized in this invention include aluminum fluoride, hexafluoro aluminate (for example, a potassium salt), aluminum chloride, basic aluminum chloride (for example, poly(aluminum chloride)), tetrachloro aluminate (for example, a sodium salt), aluminum bromide, tetrabromo aluminate (for example, a potassium salt), aluminum iodide, aluminate (for example, a sodium salt, a potassium salt and calcium salt), aluminum chlorate, aluminum perchlorate, aluminum thiocyanate, aluminum sulfate, basic aluminum sulfate, aluminum potassium sulfate(alum), aluminum ammonium sulfate(ammonium alum), aluminum sodium sulfate, aluminum phosphate, aluminum nitrate, aluminum hydrogen phosphate, aluminum carbonate, poly(aluminum silicate sulfate), aluminum formate, aluminum acetate, aluminum lactate, aluminum oxalate, aluminum isopropylate, aluminum butylate, ethylacetate aluminum diisopropylate, aluminum tris(acetylacetonate), aluminum tris(ethylacetoacetate) and aluminum monoacetylacetonate bis(ethylacetonate).

Among compounds provided with an aluminum atom according to this invention, a poly (aluminum-chloride) compound, a poly (aluminum sulfate) or a poly (aluminum sulfate silicate) compound is preferable, and among compounds provided with a zirconium atom, preferable is an acid base zirconium activated inorganic polymer.

A poly (aluminum chloride) compound is represented by general formula [Al₂(OH)ₙCl₆₋ₙ]ₘ, [Al(OH)₃]ₙ.AlCl₃, and, for example, is one stably contains a poly-nuclear condensed ion (polymeric) which is basic and has higher positive electrons such as [Al₆(OH)₁₅]³⁺, [Al₈(OH)₂₀]⁴⁺ and [Al₁₃(OH)₃₄]⁵⁺ as an effective component.

Commercially available products of poly (aluminum chloride) include, for example, poly (aluminum hydroxide) (Paho), manufactured by Asada Chemicals Co., Ltd., poly (aluminum chloride) (PAC), manufactured by Taki Chemicals Co., Ltd. and Purachem WT, manufactured by Riken Green Co., Ltd. Further, poly (aluminum sulfate) is represented by general formula [Al₂(OH)ₙ(SO₄)_{6-n/2}]ₘ (wherein, 0<n<6), and commercially available products include basic aluminum sulfate (AHS), manufactured by Asada Chemicals Co., Ltd. Commercially available products of poly(aluminum silicate sulfate) include PASS, manufactured by Nippon Light Metal Co., Ltd. Commercially available products of zirconium oxychloride activated inorganic polymers include Zircozole ZC-2, manufactured by Daiichi Rare Element Chemical Industrial Co., Ltd. In this invention, a zirconium oxychloride activated inorganic polymer is specifically preferred.

A recording sheet of this invention is preferably provided with two or more porous ink absorptive layers, one of which arranged at the most distant position from a non-absorptive support (the most surface layer) does not essentially contain the above polyvalent metal compound. In the case that a polyvalent metal compound presents in the most surface layer, dyes in ink is liable to deposit on the most surface layer and induce bronzing. “Essentially does not contain” in this invention means that at least the content of the most surface layer is not the maximum, or the content of the most surface layer is not more than 5% of the total content, when the content of a polyvalent metal compound is scanned in the depth direction of an ink absorptive layer.

In an ink absorptive layer according to a recording sheet of this invention, one of the characteristics is that an organic polymer provided with an epoxy group is incorporated together with the above polyvalent metal compound. Employing an organic polymer provided with an epoxy group in an ink absorptive layer increases an ink absorption rate. This is because swelling of polyvinyl alcohol is depressed by the cross-linking of the organic polymer, which results in an ink absorption rate based on voids being not disturbed. Further, by utilizing the organic polymer in combination with a polyvalent metal compound according to this invention, enhanced can be the prevention effect characteristic to the polyvalent metal compound against bleeding during long-term storage. Herein, the above preventing effect against bleeding is hardly observed when an organic polymer provided with an epoxy group is utilized alone. Further, it has been proved that a cracking defect in the surface, which has a tendency to be deteriorated by a polyvalent metal compound, is also depressed by addition of an organic polymer provided with in epoxy group.

Examples of an organic polymer provided with an epoxy group according to this invention include all those conventionally well known, however, in particular, polyamide.epichlorohydrin resin is preferred because of the above effects of this invention being exhibited in addition to being available on the market at low cost. Polyamide.epichlorohydrin resin is prepared generally by reacting an amide type polymer, which is obtained by condensation of diethylene triamine and adipic acid, with epichlorohydrin. In particular, to utilize a resin solution containing minimum amount of epichlorohydrine and decomposition products thereof, is preferable for the purpose of preventing the characteristic deterioration during long-term storage of the image.

In addition to above examples, an organic polymer provided with an epoxy group includes those in which a polymer provided with an amine structure reacted with epichlorohydrin. An epoxy group referred in this invention indicates not only a closed ring structure, but also an open ring structure, when it exhibits reactivity on closing the ring in alkaline solution, is regarded as an epoxy group. Such an example includes a compound in which a polydiallyl dimethylammonium.polydiallylamine copolymer is reacted with epichlorohydrin (product name: PAS-880, manufactured by Nitto Boseki Co., Ltd.).

In a recording sheet of this invention, a porous ink absorptive layer preferably contains an amino acid in addition to a polyvalent metal compound and an organic polymer provided with an epoxy group.

In this invention, an amino acid is utilized to decrease cracking defects on the recording sheet surface. The mechanism is presumed that an amino acid coordinates on a polyvalent metal compound to depress the activity of the polyvalent metal. That is, a polyvalent metal compound is easily reacts with other compounds when a coating solution is prepared because of the high reactivity. In particular, it is considered that polyvinyl alcohol may lose the stretching property, when,being cross-linked by a polyvalent metal, to decrease the capability of binding between inorganic micro-particles, resulting in inducing cracks.

An amino acid referred in this invention is a compound provided with an amino group and a carboxyl group in the same molecule, and may be any type of amino acids such as α-, β- and γ-. Optical isomers are present in some amino acids, however, there is no difference according to optical isomers so that either isomers can be utilized alone or as a rasemic modification.

A detailed explanation of an amino acid according to this invention can be referred to Kagaku Daijiten, the 1^{st} reduced-size edition, pp. 268-270 (publishedby Kyoritsu Shuppan, 1960).

In this invention, amino acids represented by following general formula (1) are preferred.
H₂N—R—COOH General formula (1)

In general formula (1), R represents an arbitrary substituent, preferably a substituent having a carbon number of not more than 11 and more preferably a substituent having a carbon number of not more than 8. Among these, specifically preferable is at least one type selected from α-monoaminomonocarboxylic acid, β-monoaminomonocarboxylic acid and γ-monoaminomonocarboxylic acid.

Preferable specific amino acids include amino carboxylic acid, glycine, alanine, valine, α-amino lactic acid, β-alanine, cerin, ε-amino-n-caproic acid, leucine, norleucine and phenyl alanine, and specifically preferable is glycine in this invention. Further, an amino acid and a polyvalent metal compound are preferably added into a coating solution after having been mixed in advance.

In a recording sheet of this invention, the surface pH of an ink absorptive layer is preferably adjusted to a range of 3.0-6.0 to exhibit the prevention effect against bleeding.

As a method to control this surface pH, it is possible to control by supplying acid or base on the surface after having been dried, however., pH of approximately in this region is obtained also by controlling pH of a coating solution itself in a range of 3.0-6.0 in the case of utilizing a water non-absorptive support. Another merit of controlling pH of a coating solution in this range is to depress reactivity of a polyvalent metal compound resulting in depressing viscosity increase of a coating solution.

A pH controlling agent utilized to control the above surface pH is most preferably acetic acid and sodium acetate or a mixture thereof, and preferably a salt containing a compound having a so-called pKa of 3.0-7.5. A pH controlling agent is preferably added into a coating solution after having been mixed with a polyvalent metal compound and an amino acid in advance, and, in particular, a mixed solution of a pH controlling agent, a polyvalent metal compound and an amino acid is most preferably added by an inline mixer into a coating solution immediately before coating.

Next, explained will be constitution elements other than those explained above of an inkjet recording sheet of this invention.

Inorganic micro-particles which can be utilized in an inkjet recording sheet of this invention include, for example, white inorganic pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium-silicate, magnesium silicate, synthetic amorphous silica, colloidal silica, alumina, colloidal alumina, pseudobohmite, aluminum hydroxide, lithopone, zeolite, and magnesium hydroxide.

In this invention, in view of obtaining a high quality print with an inkjet recording sheet, inorganic micro-particles are preferably silica or alumina, more preferably, alumina, pseudobohmite, colloidal silica or micro-particle silica synthesized by a gas phase method and specifically preferable is silica synthesized by a gas phase method. This silica synthesized by a gas phase method may be one the surface of which is modified by aluminum. The aluminum content of silica by a gas phase method the surface of which is modified by aluminum is preferably 0.05-5% based on a weight ratio against silica.

In an inkjet recording sheet of this invention, a primary mean particle diameter of utilized inorganic micro-particles is preferably not more than 10 nm, more preferably 3-10 nm and most preferably 5-10 nm.

A mean particle diameter of the above inorganic micro-particles is determined by observing the cross section or surface of a porous ink absorptive layer to measure particle diameters of arbitrary 100 particles by an electron microscope, and by simply averaging them (a number average value). Herein, the individual particle diameter is presented by a diameter of a supposed circle having the equivalent projection area.

The inorganic micro-particles described above may present as primary particles as they are or as secondary particles or more highly aggregated particles in an ink absorptive layer, however, the above-described primary particle diameter refers to a particle diameter of those forming independent particles in an ink absorptive layer when being observed through an electronmicroscope.

The content of inorganic micro-particles described above in an ink absortive layer coating solution is preferably 5-40 weight % and specifically preferable 7-30 weight %. Since a porous ink absorptive layer having a sufficient ink absorbing property and few cracks in the coated layer is required, the above-described inorganic micro-particles are contained in an ink absorptive layer at a coating amount of not less than 10 g/cm², more preferably 10-55 g/cm² and specifically preferably 10-25 g/cm².

Next, polyvinyl alcohol as a hydrophilic binder will be explained.

As a hydrophilic binder contained in a porous ink absorptive layer, there are known, generally, gelatin, polyvinyl pyrrolidone, polyethyleneoxide, polyacrylamide and polyvinyl alcohol, however, in this invention, polyvinyl alcohol among them is utilized.

Polyvinyl alcohol is provided with an interaction with inorganic micro-particles, specifically high retaining power against inorganic micro-particles as well as relatively small temperature dependence, and exhibits excellent resistance against cracking at the time of coating and drying because of a small shrinking stress at the time of coating and drying. Polyvinyl alcohols preferably utilized in this invention include also modified polyvinyl alcohols such as a polyvinyl alcohol the end of which is cationic modified and an anionic modified polyvinyl alcohol provided with an anionic group, in addition to a polyvinyl alcohol obtained by hydrolysis of polyvinyl acetate.

The mean polymerization degree of polyvinyl alcohols obtained by hydrolysis of polyvinyl acetate is preferably not lee than 2500 and not more than 5000.

Cationic modified polyvinyl alcohols, are, for example, polyvinyl alcohols provided with a primary to tertiary amino groups or a quaternary amino group in the main or side chain of the above-described polyvinyl alcohol as described in JP-A No. 61-10483, and these can be prepared by saponification of a copolymer of an ehtylenic unsaturated monomer having an cationic group with vinyl acetate.

Etylenic unsaturated monomers provided with a cationic group include, for example, trimethyl-(2-acrylamido-2,2-dimethylethyl)ammoniumchloride, trimethyl-(3-acrylamido-3,3-dimethylpropyl)ammonium chloride, N-vinyl imidazol, N-methylvinylimidazol, N-(3-dimethylaminopropyl)methacrylamide, hydroxyethyltrimethyl ammoniumchloride and trimethyl-(3-methacrylamidopropyl)ammoniumchloride.

The ratio of a cationic modified group containing monomer in a cationic modified polyvinyl alcohol is 0.1-10 mol% and preferably 0.2-5 mol % based on vinyl acetate.

Anionic modified polyvinyl alcohols include, for example, polyvinyl alcohols provided-with an anionic group described in JP-A No. 1-206088, copolymers of a polyvinyl alcohol and a vinyl compound provided with a water-soluble group, described in JP-A Nos. 61-237681 and 63-307979, and modified polyvinyl alcohols provided with a water-soluble group described in JP-A No. 7-285265.

Nonionic modified polyvinyl alcohols include, for example, polyvinyl alcohol derivatives in which a polyalkyleneoxide group is added to a part of vinyl alcohol described in JP-A No. 7-9758, and block copolymers of a vinyl compound provided with a hydrophobic group and vinyl alcohol described in JP-A No. 8-25795.

Polyvinyl alcohols may be utilized in combination of two or more types of such as different polymerization degrees and modification types. Particularly, in the case of utilizing a polyvinyl alcohol having a polymerization degree of not less than 2500, it is preferable to add in advance 0.05-10 weight % and more preferably 0.1-5 weight %, against inorganic micro-particles, followed by addition of polyvinyl alcohol-having a polymerization degree of not less than 2500, with respect to no remarkable increase of viscosity.

In an inkjet recording sheet of this invention, a ratio (F/B) of inorganic micro-particles (F) to polyvinyl alcohol (B) contained in a porous ink absorptive layer is preferably 5-30 based on a weight ratio. When the weight ratio is not less than 5 times, a porous layer having a sufficient void ratio can be obtained to easily achieve a sufficient void volume resulting in inducing no clogging of voids by swelling of a hydrophilic binder at the time of inkjet recording, which is a factor to maintain a high ink absorption rate. On the other hand, cracks are hardly generated even in the case of coating a porous ink absorption layer with a heavy layer thickness when this ratio is not more than 30 times. Ratio F/B of inorganic micro-particles to a hydrophilic binder is specifically preferably 5-20 times and most preferably 5-15 times.

In an inkjet recording sheet of this invention, a cationic polymer is preferably utilized to prevent image bleeding due to storage after recording.

Examples of the cationic polymer include such as polyethylene imine, polyallylamine, polyvinylamine, a dicyandiamido polyalkylenepolyamine condensation product, a polyalkylenepolyamine dicyandiamido ammonium salt condensation product, a dicyandiamido formalin condensation product, an epichlorohydrin.dialkylamine addition polymer, a diallyldimethylammonium chloride polymer, a diallyldimethylammonium chloride.SO₂ copolymer, polyvinyl imidazole, a vinylpyrrolidone.vinylimidazole copolymer, polyvinylpyridine, polyamidine, chitosan, cationized starch, a vinylbenzyl trimethylammonium chloride polymer, a (2-methacryloyloxyethyl)trimethylammonium chloride polymer and a dimethylaminoethyl methacrylate polymer.

Further, listed as examples are cationic polymers described in Kagaku Kogyo Jiji-Nippo, Aug. 15 and 25 (1998), and polymer dye fixing agents described in “Introduction to Polymer Medical Compounds”, published by Sanyo Chemical Industrial Co., Ltd.

In an inkjet recording sheet of this invention, a hardener for polyvinyl alcohol, which is a hydrophilic binder to form a porous ink absorptive layer, is preferably added.

Hardeners utilized in this invention are not specifically limited provided causing a curing reaction with polyvinyl alcohol, however, are preferably boric acid and salts thereof, in addition to those commonly known. They are generally compounds provided with a group reactive with polyvinyl alcohol or a compound promoting a reaction between different groups contained in polyvinyl alcohol, and utilized by suitable selection depending on types of polyvinyl alcohols. Examples of a hardener include, for example, epoxy type hardeners (such as diglycidyl ethylether, ethyleneglycol diglycidylehter, 1,4-butanediol diglycidylether, 1,6-diglycidyl cyclohexane, N,N-diglycidyl-4-glycidyloxyaniline, sorbitol polyglycidylether and glycerol polyglycidylether), aldehyde type hardeners (such as formaldehyde and glyoxal), active halogen type hardeners (such as 2,4-dichloro-4-hydroxy-1,3,5-s-triazine), active vinyl type hardeners (such as 1,3,5-trisacryloyl-hexahydro-s-triazine and bisvinylsulfonyl methylether) and aluminum alum.

Boric acid and salts thereof refers to oxyacids having a boron atom as the center atom and salts thereof, and specifically include orthoboric acid, diboric acid, methaboric acid, tetraboric acid, pentaboric acid and octaboric acid and salts thereof.

Boric acid and salts thereof, provided with a boron atom, as a hardener may be utilized as an independent aqueous solution or in combination of two or more types. Specifically preferable is a mixed solution of boric acid and borate.

Aqueous solutions of boric acid and borate each can be added only as relatively dilute solutions, however a concentrated aqueous solution can be prepared by mixing the both compounds., resulting in making a coating solution concentrated. Further, it is advantageous that a pH of an added aqueous solution can be relatively easily controlled. The total using amount of the above-described hardener is preferably 1-600 mg per 1 g of the polyvinyl alcohol described above.

In an inkjet recording sheet of this invention, added can be commonly known various additives in addition to the constitution elements explained above. For example, organic latex micro-particles such as polystyrene, polyacrylic acid esters, polymethacrylic acid esters, polyacrylamides, polyethylene, polypropylene, polyvinyl chloride, polyvinylidene chloride, or copolymers thereof, urea resin or melamine resin; cationic surfactants; ultraviolet absorbents described in JP-A Nos. 57-74193, 57-87988 and 62-261476; anti-fading agents described in such as JP-A Nos. 57-74192, 57-87989, 60-72785, 61-146591, 1-95091 and 3-13376; fluorescent whitening agents described in such as JP-A Nos. 59-42993, 59-52689, 62-280069, 61-242871 and 4-219266; pH controlling agents such as sulfuric acid, phosphoric acid, citric acid, sodium hydroxide, potassium hydroxide and potassium carbonate; commonly known various additives such as defoarming agents, viscosity increasing agents, anti-static agents and matting agents.

As a water non-absorptive support utilized in this invention, those conventionally well known as an inkjet recording sheet can be applied, and there are a transparent support and an opaque support. Transparent supports include films comprising polyester type resin, diacetate type resin, triacetate type resin, acrylic type resin, polycarbonate type resin, polyvinyl chloride type resin, polyimide type resin, cellophane and celluloid, and among them preferable are those resistant against radiation heat when being applied in an OHP and specifically preferable is polyethylene terephthalate. The thickness of such a transparent support is preferably 50-200 μm.

Further, opaque supports are preferably resin laminated paper provided with a polyolefin resin covering layer, in which such as a white pigment is added, on one side of the base paper (so-called RC paper) and so-called white PET comprising polyethylene terephthalate added with a white pigment such as barium sulfate.

It is preferable to provide such as a corona discharge treatment or an under-coating treatment on a support before coating of a porous ink absorptive layer, for the purpose of enhancing an adhesion strength between various supports described above and a porous ink absorptive layer. Further, an inkjet recording sheet according to this invention is not necessarily colorless, but may be a colored recording sheet.

With respect to an inkjet recording sheet of this invention, to utilize paper support in which the both side of the base paper are laminated with polyethylene is specifically preferable because recorded images exhibit near photographic image quality as well as high quality images can be obtained-at low cost.

Such a polyethylene laminated paper support will be explained below.

Raw paper utilized for a paper support is primarily comprised of wood pulp, and made into paper by appropriately incorporating-synthetic pulp such as polypropylene or synthetic fiber such as nylon and polyester in addition to wood pulp. As wood pulp utilized can be any of LBKP, LBSP, NBKP, NBSP, LDP, NDP, LUKP and NUKP, however, it is preferable to utilize more LBKP, NBSP, LBSP, NDP and LDP which are rich in a short fiber component. Herein, a ratio of LBSP and/or LDP is preferably 10-70 weight %.

As pulp described above, chemical pulp containing minimum impurities (such as sulfate pulp and sulfite pulp) is preferably utilized and pulp whiteness of which is improved by a bleach treatment is also useful.

In raw paper, suitably added can be sizing agent such as a higher fatty acid and an alkylketene dimmer; whitening agents such as calcium carbonate, talc and titanium oxide; paper strength increasing agents such as starch, polyacrylamide and polyvinyl alcohol; fluorescent whitening agents; moisture retaining agents such as polyethylene glycol; dispersants; softening agents such as quaternary ammonium.

A drainage of pulp utilized in paper making is preferably 200-500 ml based on the definition of CSF, and a fiber length after beating is preferably 30-70% as the sum of a weight % of a 24 mesh residue and a weight % of a 42 mesh residue based on the definition of JIS-P-8207. Herein, a weight % of a 4 mesh residue is preferably not more than 20 weight %. A basis weight of paper is preferably 30-250 g and specifically preferably 50-200 g. A thickness of paper is preferably 40-250 μm. Paper may be subjected to a calendar treatment during or after paper making to be provided with a high smoothness. A density of paper is generally 0.7-1.2 g/m² (JIS-P-8118). Further, a stiffness of raw paper is preferably 20-200 g based on the conditions defined in JIS-P-8143. A surface sizing agent may be coated on the surface of paper, and sizing agents, similar to those can be added in the aforesaid raw paper, can be utilized as the surface sizing agent. A pH of paper is preferably 5-9 when being measured according to a hot water extraction method defined in JIS-P-8113.

Polyethylene covering the front and back surfaces of raw paper is primarily law density polyethylene (LDPE) and/or high density polyethylene (HDPE), however, others such as LLDPE (linear law density polyethylene) and polypropylene can be partly utilized.

A polyethylene layer of a porous ink absorptive layer side is preferably one opacity and whiteness of which having been improved by addition of titanium oxide of a rutile or anatase type therein, as commonly applied in photographic print paper. A content of titanium oxide is generally 3-20 weight % and preferably 4-13 weight % based on polyethylene.

Polyethylene laminated paper can be utilized as glossy paper, and utilized in this invention can be paper provided with a matt surface or a silk surface, similar to those prepared in ordinary photographic print paper, by a so-called embossing treatment when polyethylene is fusing extruded to be coated on the raw paper surface. It is especially preferable that aforesaid polyethylene laminated paper retains its paper's water content from 3% to 10% by weight.

An inkjet recording sheet of this invention can be manufactured by coating each constituent layer including a porous ink absorptive layer on a support, each independently or simultaneously by means of a suitably selected commonly known coating method, followed by drying. As a coating method, preferably utilized are, for example, a roll coating method, a rod-bar coating method, an air-knife coating method, a spray coating method, a curtain coating method, as well as a slide bead coating method described in U.S. Pat. Nos. 2,761,419 and 2,761,791, and an extrusion coating method.

The viscosity of each coating solution when performing simultaneous multi-layer coating is preferably in a range of 5-100 mPa.s and more preferably in a range of 10-50 mPa.s, in the case of employing a slide-bead coating method. Further, it is preferably in a range of 5-1200 mPa.s and more preferably in a range of 25-500 mPa.s, in the case of employing a curtain coating method.

Further, the viscosity of a coating solution at 15° C. is preferably not less than 100 mPa.s, more preferably 100-30,000 mPa.s, furthermore preferably 3,000-30,000 mPa.s and most preferably 10,000-30,000 mPa.s.

As a coating and drying method, it is preferable that after a coating solution is heated at 30° C. or more and coated, the formed coated layer is once cooled to 1-15° C. and dried at not lower than 10° C., and more preferable as the drying condition are a wet bulb of 5-50° C. and a film surface temperature of 10-50° C. Further, as a cooling method immediately after coating, it is preferably performed by a horizontal set method with respect to a uniformity of a coated layer.

Further, when an inkjet recording sheet is stored, an inkjet recording sheet according to this invention is preferably stored being kept as a roll form or having been cut into a sheet form after having been over-coated and dried. When being stored for a certain period, for example, for 1 day-1 month, at not lower than 30° C., an ink absorption rate is further improved which results in contribution to decrease mottled unevenness of formed image. A preferable storing condition is 1-30 days at 30-50° C.

Next, ink utilized in an inkjet recording method will be explained.

For an inkjet recording sheet of this invention, an inkjet recording method employing a water-soluble dye ink is specifically preferable because of large effects of the invention, however, an inkjet recording method employing a pigment ink is also utilized. Further, when recording images employing an inkjet recording sheet of this invention, an inkjet recording method employing a water-based ink is preferred.

A water-based ink described above is a recording liquid comprising the colorants, solvents and other additives described below. As colorants, utilized can be direct dyes, acid dyes, basic dyes and reactive dyes, which are commonly known in inkjet application, water-based dyes such as food dyes, or water-based dispersion pigments.

Solvents of a water-based ink include water and various organic solvents: for example, alcohols such as methyl alcohol, isopropyl alcohol, butyl alcohol, tert-butyl alcohol and isobutyl alcohol; amides such as dimethylformamide and dimethylacetoamide; ketones or ketone alcohols such as acetone and diacetone alcohol; ethers such as tetrahydrofuran and dioxane; polyalkylene glycols such as polyethylene glycol and polypropylene glycol; polyhydric alcohols such as ethylene glycol, propylene glycol, butylenes glycol, triethylene glycol, 1,2,6-hexane triol, thiodiglycol, hexylene glycol, diethylene glycol, glycerin and triethanol amine; lower alkyl ethers of polyhydric alcohols such as ethylene glycol methylether, diethylene glycol methyl(or ethyl) ether and triethylene glycol monobutylether. Among them, preferable are polyhydric alcohols such as diethylene glycol, triethanol amine and glycerin; and lower alkyl ethers of polyhydric alcohols such as triethylene glycol monobutylether.

In an inkjet recording method, image recording is preferably performed by ejecting ink having a content ratio of the organic solvent described above of not less than 20 weight %, and the content ratio of an organic solvent of ink is preferably 20-60 weight % and more preferably 20-50 weight %.

Other additives for a water-based ink include, for example, pH controlling agents, metal blocking agents, anti-mold agents, viscosity controlling agents, surface tension controlling agents, wetting agents, surfactants and anti-stain agents.

A water-based ink preferably has a surface tension of, generally in a range of 25-60 mN/m at 20° C. and preferably in a range of 30-50 mN/m, to improve wettability against a recording sheet. A pH of the above-described ink is preferably 5-10 and specifically preferably 6-9.

### EXAMPLES

In the following, this invention will be explained referring to examples, however, the invention is not limited to these examples. Herein, “%” in examples represents weight % unless otherwise mentioned.

### Example 1

<Preparation of Inorganic Micro-Particles Dispersion>

[Preparation of Silica Dispersion D-1]

Silica dispersion B-1 (pH=2.6, containing 0.5% of ethanol), being homogeneously dispersed in advance and containing 25% of gas phase silica (Aerosil 300, manufactured by Nippon Aerosil Co., Ltd.) having a mean particle diameter of a primary particle of approximately 0.007 μm, of 400 L was added, at room temperature with stirring at 3000 rpm, into 110 L of aqueous solution C-1 (pH=2.5, containing defoarming agent SN-381, manufactured by Sunnopco Co., Ltd.) containing 12% of cationic polymer P-1, 10% of n-propanol and 2% of ethanol. Next, 54 L of mixed aqueous solution A-1 (each concentration of 3%) containing boric acid and borax at a weight ratio of 1/1 were gradually added with stirring to the resulting solution.

Then, the resulting solution was dispersed at 3 kN/cm² pressure by a high pressure homogenizer, produced by Sanwa Industrial Co., Ltd., and the total volume was made up to 630 L with pure water to prepare nearly transparent silica dispersion D-1.

[Preparation of Silica Dispersion D-2]

Silica dispersion B-1 of 400 L was added at room temperature with stirred at 3000 rpm into 120 L of aqueous solution C-2 (pH=2.5) containing 12% of cationic polymer P-2, 10% of n-propanol and 2% of ethanol, then 52 L of above-described mixed aqueous solution A-1 were gradually added with stirring to the resulting solution. Next, the resulting solution was dispersed at 3 kN/cm² pressure by a high pressure homogenizer, produced by Sanwa Industrial Co., Ltd., and the total volume was made up to 630 L with pure water to prepare nearly transparent silica dispersion D-2.

Cationic polymer P-1

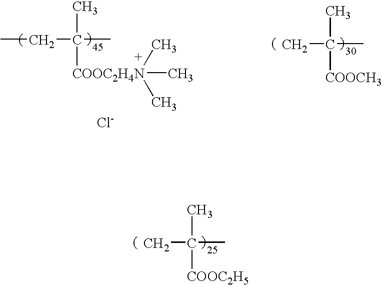

Cationic polymer P-2

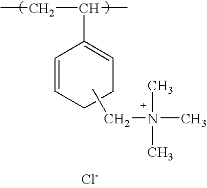

Silica dispersions D-1 and D-2 each were filtered through a TCP-30 type filter manufactured by Advantech Toyo Co., Ltd., which has a filtering precision of 30 μm.

<Preparation of Recording Sheet 1>

[Preparation of Ink Absorptive Layer Coating Solution]

Each coating solution for a porous ink absorptive layer was prepared by utilizing the above-described each silica dispersion and successively mixing the following each additive. Herein, each addition amount is presented as an amount per 1 L of a coating solution.

(The First Layer Coating Solution: Under-Most Layer)

Silica dispersion D-1 580 ml

Polyvinyl alcohol (PVA 203, manufactured by Kraray Co., Ltd.) 10% aqueous solution 5 ml

Polyvinyl alcohol (mean polymerization degree: 3800, saponification degree: 88%) 6.5% aqueous solution 290 ml

The total volume was made up to 1000 ml with pure water.

(The Second Layer Coating Solution)

Silica dispersion D-1 580 ml

Polyvinyl alcohol (PVA 203, manufactured by Kraray Co., Ltd.) 10% aqueous solution 5 ml

Polyvinyl alcohol (mean polymerization degree: 3800, saponification degree: 88%) 6.5% aqueous solution 270 ml

The total volume was made up to-1000 ml with pure water.

(The Third Layer Coating Solution)

Silica dispersion D-2 630 ml

Polyvinyl alcohol (PVA 203, manufactured by Kraray Co., Ltd.) 10% aqueous solution 5 ml

Polyvinyl alcohol (mean polymerization degree: 3800, saponification degree: 88%) 6.5% aqueous solution 270 ml

10% aqueous solution of urea 36 ml

The total volume was made up to 1000 ml with pure water.

(The Forth Layer Coating Solution: Upper-Most Layer)

Silica dispersion D-2 660 ml

Polyvinyl alcohol (PVA 203, manufactured by. Kraray Co., Ltd.) 10% aqueous solution 5 ml

Polyvinyl alcohol (mean polymerization degree: 3800, saponification degree: 88%) 6.5% aqueous solution 250 ml

10% aqueous solution of urea 36 ml

Surfactant (Megafac F-120, manufactured by Dainippon Ink & Chemicals Inc., an anionic fluorine type surfactant) 4% aqueous solution 9.0 ml

The total volume was made up to 1000 ml with pure water.

Coating solutions prepared above each were filtered through a TCPD-30 filter manufactured by Advantech Toyo Co., Ltd., which has a filtering precision of 20 μm, followed by being filtered through a TCPD-10 filter.

[Formation of Ink Absorptive Layer]

Next, four coating solutions prepared above each were simultaneously multi-coated on a paper support, the both surface of which are laminated with polyethylene, (RC paper) by use of a slide hopper type coater under conditions to make the wet layer thicknesses described below.

<Wet Layer Thickness>

The first layer: 42 μm

The second layer: 39 μm

The third layer: 44 μm

The fourth layer: 38 μm

Herein, as RC paper described above, the following support, which was wound in a roll form of 1.5 width and approximately 4000 m long, was utilized.

In utilized RC paper, the front surface of photographic raw paper having-a moisture content of 8% and.a basis weight. of 170 g was extrusion fusing coated with polyethylene containing 6% of anatase type titanium oxide at a thickness of 35 μm, and the back side was extrusion fusing coated with polyethylene of 40 μm at a thickness of 35 μm. The front surface was coated with an undercoat layer comprising polyvinyl alcohol (PVA 235, manufactured by Kraray Co., Ltd.) so as to make 0.05 g per support of 1 m² after having been subjected to corona discharge, and the back side surface was coated with a back-coat layer containing approximately 0.4 g of a styrene.acrylic acid ester type latex binder, a glass transition temperature Tg of which is approximately 80° C., 0.1 g of an anti-static agent (a cationic polymer) and 0.1 g of silica having a particle size of approximately 2 μm as a matting agent, after having been subjected to a corona discharge.

As described above, after coating each ink absorption layer coating solution on RC paper, the coated paper was passed through a cooling zone kept at 5° C. for 15 seconds to cool the surface temperature down to 13° C., then the coated layer was dried by suitably setting temperatures of a plural number of drying zones followed by being wound in a roll form resulting in preparation of recording sheet 1.

[Preparation of Recording Sheets 2 and 3]

Recording sheets 2 and 3 were prepared in a similar manner to the preparation of above recording sheet 1, except that addition solutions comprising compositions described in Table 1 were inline added immediately before coating by use of a static mixer, produced by Toray Engineering Co., Ltd.

[Preparation of Recording Sheets 4-11]

In the preparation of above recording sheets 1, each 0.1 g/m² (a total of 0.2 g/m²) of organic polymers provided with an epoxy group described in Table 1 was added into the third layer coating solution and the fourth layer coating solution. Recording sheets 4-11 were prepared in a similar manner to the preparation of above recording sheet 1, except that addition solutions comprising compositions described in Table 1 were further inline added immediately before coating by use of a static mixer, produced by Toray Engineering Co., Ltd.

Herein, in each additive described in Table 1, added were polyvalent metal compound so as to make 0.25 g/m² and amino acid so as to make 0.25 g/m², further, sodium acetate was added so as to make the surface pH described in Table 1.

Further, each-additive used in the preparation of recording sheets 2-11 is as follows.

<Polyvalent Metal Compound>

ZC-2: A zirconium oxychloride activated inorganic polymer (Zircozole ZC-2, manufactured by Daiichi Rare Element Chemical Industry Co., Ltd.)

ZA: Zirconyl acetate (Zircozole ZA, manufactured by Daiichi Rare Element Chemical Industry Co., Ltd.)

PAC: Basic poly(aluminum chloride) (PAC, manufactured by Taki Chemicals Co., Ltd.)

<Organic Polymer Provided with Epoxy Group>

WS552: Polyamide-epichlorohydrin resin (WS-552, manufactured by Seiko PMC Co., Ltd.)

PAS-880: Polyamine type resin (PAS-880, manufactured by Nitto Boseki Co., Ltd.)

[Preparation of Recording Sheets 12-15]

Recording sheets 12-15 were prepared in a similar manner to the preparation of above recording sheet 9, except that sodium acetate was eliminated from the inline adding solution, and nitric acid or sodium carbonate was suitably added into the third layer coating solution to change the surface pH as described in Table 1.

(Preparation of Recording Sheet 16]

Recording sheet 16 was prepared in a similar manner to the preparation of above recording sheet 9, except that the inline adding solution was added not into the third layer but into the fourth layer.

[Preparation of Recording Sheet 17]

Recording sheet 17 was prepared in a similar manner to the preparation of above recording sheet 9, except that 90% of the inline adding solution was added into the third layer and 10% into the fourth layer, respectively.

[Preparation of Recording Sheet 18]

Recording sheet 18 was prepared in a similar manner to the preparation of above recording sheet 7, except that the inline adding solution was not inline added but over-coated by a wire-bar coating method after a recording sheet having been prepared.

[Preparation of Recording Sheet 19]

Recording sheet 19 was prepared in a similar manner to the preparation of above recording sheet 9, except that sodium succinate was utilized instead of sodium acetate in the inline adding solution.

[Preparation of Recording Sheet 20]

Recording sheet 20 was prepared in a similar manner to the preparation of above recording sheet 9, except that an organic polymer provided with an epoxy group in the third layer was eliminated.

Herein, as a result of measuring the distribution state of a polyvalent metal element in each ink absorptive layer, with respect to each recording sheet prepared above, according to EDS analysis (energy-dispersive X-ray spectroscopy) of the cross sectional plane, it has been proved that an aluminum atom presents in the neighborhood of the surface layer most densely in recording sheet 18.

<Evaluation of Recording Sheet>

The following evaluations were performed with respect to recording sheet 1-20 obtained above.

[Evaluation of Anti-Bleeding Property]

On each recording sheet, a fine line of approximately 0.3 mm width was printed with a black ink on the magenta solid image background with a pure magenta ink, by use of Inkjet Printer PM920C produced by Seiko-Epson Co., Ltd. Then, after the both surfaces of samples were accumulating with each three sheets of a paper support utilized in preparation of a recording sheet and fixed with a rubber band immediately after printing, the accumulated samples were kept under environment of 50° C. and a relative humidity of 85% for 7 days. Next, the line width of a black ink was measured with a micro-densitometer before and after storage (the portion having a 50% reflective density of the maximum density was designated as a line width), and a bleeding ratio, which was designated as an anti-bleeding property, was calculated according to the following equation.
Bleeding ratio=(line width after storage of an image)/(line width before storage of an image)
[Evaluation of Ink Absorbability]

A transferred amount (ml/m²) at a contact time of 0.08 second, which was designated as a measure of ink absorbability, was measured by use of a Bristor testing instrument described in J. TAPPI's paper and pulp test method No. 51-87. Herein, in the measurement, utilized was pure water colored with a pure magenta ink for Inkjet Printer PM920C, produced by Seiko-Epson Co., Ltd.

[Evaluation of Anti-Cracking Characteristic]

The state of generation of cracks on the coated layer of an ink absorptive layer of 1.0 m² with respect to each recording sheet was observed by use of a loupe, and a number of cracking defects of not shorter than 0.5 mm, which was designated as a measure of an anti-cracking characteristic, was counted.

[Evaluation of Anti-Bronzing Characteristic]

Glare appearance of the printed surface was visually observed by printing a block blue image-with a pure ink, by use of Inkjet Printer PM920, produced by Seiko-Epson Co., Ltd. on each recording sheet. As the result, recording sheet 18 exhibited a significant glare appearance, which does not fit to appreciation. Further, recording sheets 16 and 18 exhibited a glare appearance although it is acceptable quality. On the other hand, other recording sheets hardly exhibited a glare appearance, and have been proved to be provided with an excellent anti-bronzing characteristic. The results except the anti-bronzing characteristic are shown in Table 1.

TABLE 1

| | | | | | | | | Evaluation results | | | |
|---|---|---|---|---|---|---|---|---|---|---|---|
| | Additive solution composition | | | | | | | Anti- | | | |
| Re- | | Poly- | | | | | | bleeding | Ink | Anti- | |
| cording | | valent | | Addi- | Organic polymer | | Sur- | property | absorb- | cracking | |
| sheet | Addition | metal | Amino | tion | Addition | | face | (bleeding | ability | property | Re- |
| No. | layer | compound | acid | method | layer | Type | pH | ratio) | (ml/m²) | (number/m²) | marks |
| 1 | — | — | — | — | — | — | 4.3 | 2.83 | 10.7 | 7 | Comp. |
| 2 | 3rd layer | ZC-2 | — | In-line | — | — | 4.5 | 1.36 | 12.1 | 53 | Comp. |
| 3 | 3rd layer | PAC | — | In-line | — | | 4.5 | 1.74 | 12.5 | 74 | Comp. |
| 4 | 3rd layer | — | — | In-line | 3rd & 4th | WS-552 | 4.5 | 2.67 | 12.9 | 10 | Comp. |
| 5 | 3rd layer | ZC-2 | — | In-line | 3rd & 4th | WS-552 | 4.5 | 1.13 | 15.5 | 16 | Inv. |
| 6 | 3rd layer | ZA | — | In-line | 3rd & 4th | WS-552 | 4.5 | 1.11 | 15.4 | 19 | Inv. |
| 7 | 3rd layer | PAC | — | In-line | 3rd & 4th | WS-552 | 3.5 | 1.30 | 15.7 | 23 | Inv. |
| 8 | 3rd layer | ZC-2 | — | In-line | 3rd & 4th | PAS-880 | 4.5 | 1.21 | 14.9 | 26 | Inv. |
| 9 | 3rd layer | ZC-2 | Glycine | In-line | 3rd & 4th | WS-552 | 4.5 | 1.07 | 16.6 | 9 | Inv. |
| 10 | 3rd layer | ZA | Glycine | In-line | 3rd & 4th | WS-552 | 4.5 | 1.09 | 15.4 | 11 | Inv. |
| 11 | 3rd layer | ZC-2 | β-alanine | In-line | 3rd & 4th | WS-552 | 4.5 | 1.13 | 15.8 | 14 | Inv. |
| 12 | 3rd layer | ZC-2 | Glycine | In-line | 3rd & 4th | WS-552 | 2.8 | 1.01 | 13.2 | 30 | Inv. |
| 13 | 3rd layer | ZC-2 | Glycine | In-line | 3rd & 4th | WS-552 | 3.3 | 1.05 | 14.4 | 19 | Inv. |
| 14 | 3rd layer | ZC-2 | Glycine | In-line | 3rd & 4th | WS-552 | 5.5 | 1.21 | 16.5 | 7 | Inv. |
| 15 | 3rd layer | ZC-2 | Glycine | In-line | 3rd & 4th | WS-552 | 6.4 | 1.42 | 16.9 | 14 | Inv. |
| 16 | 4th layer | ZC-2 | Glycine | In-line | 3rd & 4th | WS-552 | 4.5 | 1.10 | 14.7 | 15 | Inv. |
| 17 | *1 | ZC-2 | Glycine | In-line | 3rd & 4th | WS-552 | 4.5 | 1.08 | 15.8 | 14 | Inv. |
| 18 | Surface | PAC | — | Over | 3rd & 4th | WS-552 | 3.5 | 1.19 | 14.3 | 8 | Inv. |
| | layer | | | coat | | | | | | | |
| 19 | 3rd layer | ZC-2 | Glycine | In-line | 3rd & 4th | WS-552 | 4.3 | 1.11 | 15.2 | 18 | Inv. |
| 20 | 3rd layer | ZC-2 | Glycine | In-line | 4th | WS-552 | 4.5 | 1.08 | 16.2 | 8 | Inv. |

*1: addition of 90% in the third layer and 10% in the fourth layer
Comp.: Comparison
Inv.: Invention

It is clear from Table 1 that recording sheets of this invention, in which a polyvalent metal compound provided with a polyvalent metal element and an organic polymer provided with an epoxy group are contained at least in one layer of ink absorptive layers, are excellent in an anti-bleeding characteristic, ink absorbability and an anti-cracking characteristic compared to comparative examples. Further, among this invention, it has been proved that a recording sheet containing an amino acid, a recording sheet containing polyamide-epichlorohydrin as an organic polymer provided with an epoxy group, a recording sheet containing a compound provided with zirconium or a zirconium oxychloride activated inorganic polymer as a polyvalent metal compound, or a recording sheet in which a layer containing a polyvalent metal compound is not the upper-most layer exhibits more preferable effects. Further, a recording sheet, a surface pH of which is adjusted to a range of 3.0-6.0, has been proved to exhibit most preferable balance of an anti-bleeding property, ink absorbability and an anti-cracking property.

1. An inkjet recording sheet comprising on a water-nonabsorptive support a porous ink absorptive layer, wherein; said porous ink absorptive layer is formed by utilizing a composition containing inorganic micro-particles, polyvinyl alcohol and an organic polymer having an epoxy group, and contains a polyvalent metal compound provided with a polyvalent metal element.

2. The inkjet recording sheet of claim 1, wherein said polyvalent metal compound is a compound provided with a zirconium atom or an aluminum atom in the molecule as a polyvalent metal element.

3. The inkjet recording sheet of claim 2, wherein said polyvalent metal element is a zirconium.

4. The inkjet recording sheet of claim 2, wherein-said polyvalent metal compound is a zirconium oxychloride activated inorganic polymer.

5. The inkjet recording sheet of claim 1, comprises two or more porous ink absorptive layers, and one of which arranged at most distant position from the non-absorptive support contains essentially no polyvalent metal compound.

6. The inkjet recording sheet of claim 1, wherein said organic polymer having an epoxy group is a polyamide.epi-clolohydrin resin.

7. The inkjet recording sheet of claim 1, wherein said porous ink absorptive layer comprises an amino acid.

8. The inkjet recording sheet of claim 7, wherein the amino acid is represented by following general formula (1).
H₂N—R—COOH General formula (1)
wherein R represents an substituent.

9. The inkjet recording sheet of claim 1, wherein the surface pH of the porous ink absorptive layer is from 3.0 to 6.0.
